(19) United States
(12) Patent Application Publication
(10) Pub. No.: US 2015/0114821 A1
(43) Pub. Date: Apr. 30, 2015

(54) Method for Modifying Properties of Graphene

(71) Applicant: METAL INDUSTRIES RESEARCH & DEVELOPMENT CENTRE, Kaohsiung City (TW)

(72) Inventors: Chia-Hung Huang, Kaohsiung City (TW); Chi-Wen Chu, Kaohsiung City (TW); Sung-Mao Chiu, Kaohsiung (TW); Chun-Chieh Wang, Kaohsiung City (TW); Chia-Min Wei, Kaohsiung City (TW); Chung-Jen Chung, Kaohsiung City (TW); Bo-Hsiung Wu, Kaohsiung City (TW)

(73) Assignee: METAL INDUSTRIES RESEARCH & DEVELOPMENT CENTRE, Kaohsiung City (TW)

(21) Appl. No.: 14/231,792

(22) Filed: Apr. 1, 2014

(30) Foreign Application Priority Data
Oct. 29, 2013 (TW) 102139135

(51) Int. Cl. B01J 19/08

(52) U.S. Cl. CPC B01J 19/085
USPC 204/157.44

(57) ABSTRACT

A method for modifying properties of graphene includes a graphene film provision step and a modification step. In the graphene film provision step, a graphene film is provided, and the graphene is formed on a substrate. In the modification step, the graphene film is placed in a vacuum environment and radiated by an electron beam to obtain a graphene material.

### BACKGROUND OF THE INVENTION

1. Field of the Invention

The present invention relates to a method for modifying properties of graphene and, more particularly, to a method for modifying semiconductor properties of graphene.

2. Description of the Related Art

Graphene is a substantially plan film having hexagonal lattices and is a two-dimensional material having a thickness (about 0.34 nm) of a carbon atom. In addition to excellent properties including high mechanical strength, high thermal conduction, and high carrier transfer efficiency, the semiconductor properties of graphene can be modified to develop electric elements or transistors that are thinner and that have a higher current conduction speed.

Conventional methods for modifying semiconductor properties include thermal diffusion and ion implantation. In thermal diffusion, atoms to be doped are driven by a high temperature not lower than 500° C. into a semiconductor film and a substrate coupled to the semiconductor film for diffusion purposes. However, thermal diffusion must be carried out in a high temperature environment that easily damages the semiconductor film. In ion implantation, collision of ionized elements is carried out under a high voltage to change the physical properties. Although ion implantation can be carried out without a high temperature environment, the collision between ionized elements causes serious damage to the structure of the semiconductor film and, thus, requires annealing to repair the structure.

Although the above methods can be used to modify the structural properties of semiconductor films, serious damages are caused due to the small thickness (about 0.34 nm) of graphene. Namely, the above methods are not suitable.

Furthermore, in the above methods, the whole semiconductor film must be placed in a high temperature or high voltage environment. Modification to properties of a small area graphene is difficult.

Thus, a need exists for a novel method for modifying semiconductor properties of graphene to mitigate and/or obviate the above disadvantages.

### SUMMARY OF THE INVENTION

The primary objective of the present invention is to provide a method for modifying properties of graphene to provide graphene with semiconductor properties.

Another objective of the present invention is to provide a method for modifying properties of graphene that is less likely to damage graphene to simplify subsequent procedures for repairing damaged graphene.

A further objective of the present invention is to provide a method allowing modification to properties of graphene having a small area, increasing applications of graphene materials.

The present invention fulfills the above objectives by providing a method for modifying properties of graphene including: a graphene film provision step including providing a graphene film, with the graphene formed on a substrate; and a modification step including placing the graphene film in a vacuum environment and radiating the graphene film with an electron beam to obtain a graphene material.

Preferably, the electron beam has an accelerating voltage of 50 KeV, has a radiating energy in a range of 200-1200 μC/cm², and has a current intensity of 70-120 pA.

Preferably, the graphene is formed on the substrate by physical vapor deposition.

Preferably, the substrate is a silicon chip.

Preferably, the substrate is an electric element or a transistor.

In the method for modifying properties of graphene according to the present invention, the graphene film is radiated with an electron beam to effectively control the it bond of the graphene film, altering the energy band characteristics of the graphene film and obtaining the graphene material with semiconductor properties.

Furthermore, in the method for modifying properties of graphene according to the present invention, the graphene film is radiated with an electron beam in a low temperature environment to avoid damage to the graphene material resulting from a high temperature environment. The subsequent procedures for repairing damaged graphene material is, thus, not required, simplifying the producing procedures and reducing the industrial costs.

The method for modifying properties of graphene according to the present invention uses an electron beam that can be accurately located and can be qualitatively controlled. Thus, a small modification area can be scanned with the electron beam. Furthermore, the current intensity (e.g., 70-120 pA), the scanning time (e.g., 0.1-0.4 μms per point), and the accelerating voltage (e.g., 50 KeV) of the electron beam can respectively be controlled such that the radiating energy of the electron beams is in a range of 200-1200 μC/cm², which is sufficient to modify the semiconductor properties to different extents (i.e., the property modification extent of graphene). Thus, different property modification needs of different products can be fulfilled, which is an effect of the present invention.

The present invention will become clearer in light of the following detailed description of illustrative embodiments of this invention described in connection with the drawings.

### BRIEF DESCRIPTION OF THE DRAWINGS

FIG. 1 is a Raman spectrum analysis of graphene materials of test examples.

FIG. 2 is a diagram showing D-band strength and G-band strength versus the radiating energy of the electron beam of FIG. 1.

FIG. 3 is a diagram showing a ratio of D-band strength to G-band strength and a ratio of 2D-band strength to G-band strength versus the radiating energy of the electron beam of FIG. 1.

### DETAILED DESCRIPTION OF THE INVENTION

A method for modifying properties of graphene according to the present invention includes a graphene film provision step and a modification step to obtain a graphene material.

Specifically, the graphene film provision step includes providing a graphene film. The graphene film is formed on a substrate. The substrate can be a surface of an electric element or transistor, and graphene is formed on the surface. The substrate can be made of silicon, glass, or plastic.

Graphene can be formed on the substrate by any method, such as chemical vapor deposition, physical vapor deposition, or mechanical exfoliation, which is known in the art.

The graphene material is obtained after the modification step modifying properties of the graphene film. Specifically, the graphene film is placed in a vacuum environment and is radiated with an electron beam. In the preferred embodiment, the electron beam has an accelerating voltage of 50 KeV, has a radiating energy in a range of 200-1200 μC/cm², and has a current intensity of 70-120 pA. Thus, the π bond of the graphene film can be controlled to alter band energy characteristics of the graphene film, obtaining the graphene material with semiconductor properties.

Tests were conducted to prove the method for modifying properties of graphene according to the present invention can modify the semiconductor properties of graphene. In the tests, silicon chips were used as substrates. Graphene was formed on the silicon chips by physical vapor deposition to obtain the graphene films. Then, the graphene films were radiated with electron beams with different energies obtain the graphene material of each group in the tests.

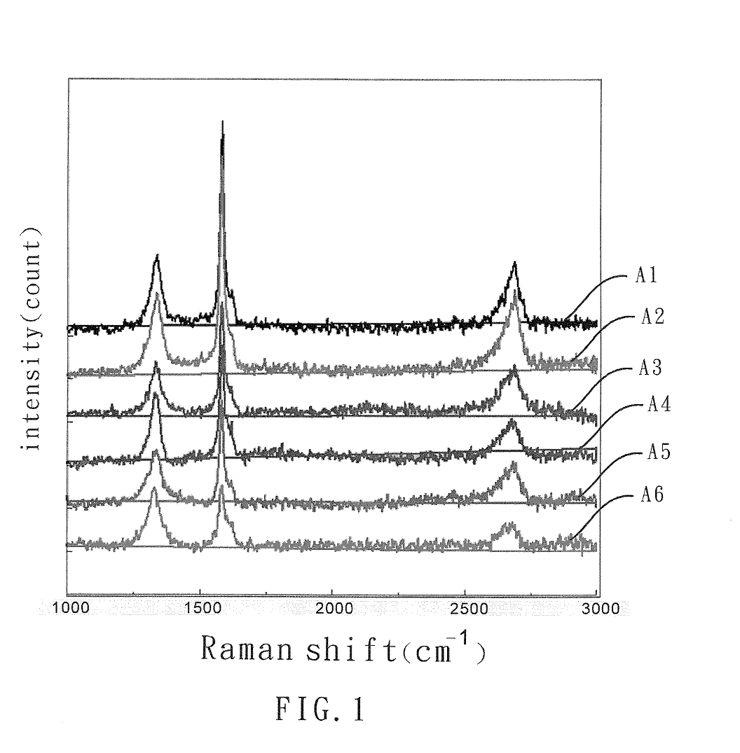

With reference to FIG. 1, graphene films of groups A1, A2, A3, A4, A5, and A6 were respectively radiated with electron beams with different radiating energies of 200 μC/cm², 400 μC/cm², 600 μC/cm², 800 μC/cm², 1000 μC/cm², and 1200 μC/cm² to obtain the graphene material of each group in the tests. The characteristic peaks (D-band, G-band, and 2D-band) of the graphene materials were analyzed with Raman spectrum analysis. Table 1 shows the test results.

TABLE 1
Results of Raman spectrum analysis
of the groups of graphene materials

| Group | D-band | G-band | 2D-band | D/G ratio |
|---|---|---|---|---|
| A1 | 340.433 | 958.344 | 337.047 | 0.355230 |
| A2 | 371.082 | 1001.670 | 391.073 | 0.370463 |
| A3 | 270.275 | 535.908 | 255.512 | 0.504330 |
| A4 | 325.090 | 545.876 | 208.129 | 0.595540 |
| A5 | 271.346 | 403.926 | 161.158 | 0.671770 |
| A6 | 283.022 | 309.643 | 126.206 | 0.914027 |

5

As can be seen from Table 1, when the radiating energy of the electron beam increased, the value of the crystal phase (i.e., G-band) of the graphene film significantly decreased, and the value of the defect phase (i.e., D-band) slightly decreased.

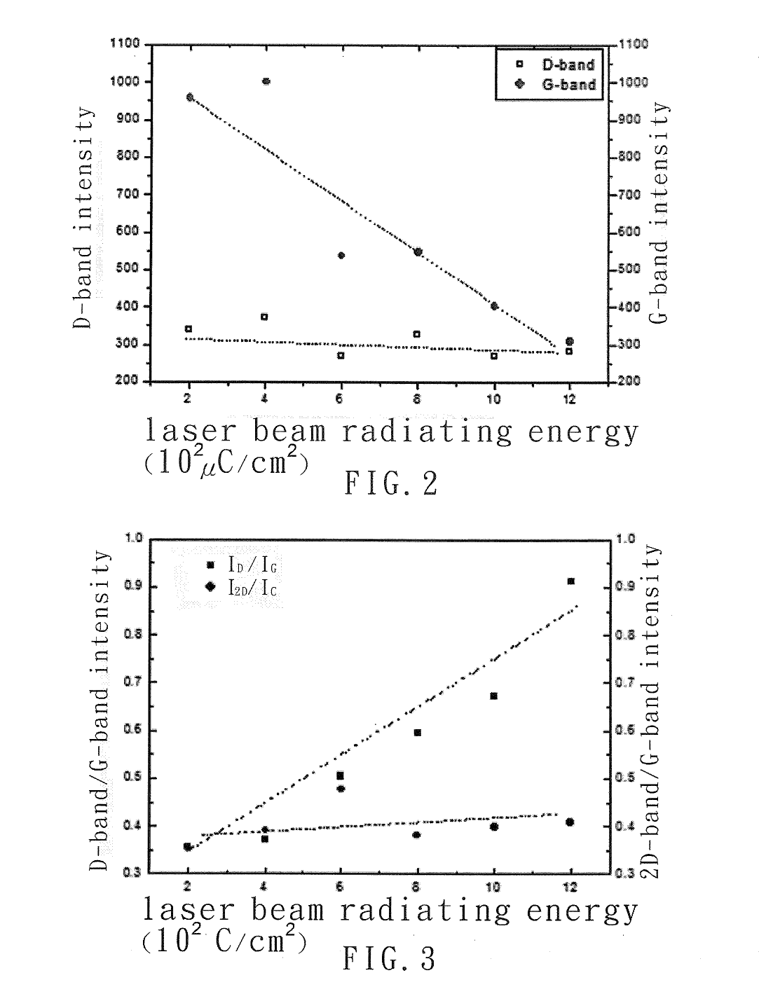

FIG. 2 shows a diagram obtained by drawing the D-band intensity and G-band intensity versus the radiating energy of the electron beam. FIG. 3 shows a diagram obtained by drawing the ratio of D-band to G-band and the ratio of 2D-band to G-band versus the radiating energy of the electron beam.

As can be seen from FIGS. 2 and 3, when the radiating energy of the electron beam increased, the value of G-band and the value of D-band decreased. This was because the electron beam formed charged impurities in the graphene film and, thus, reduced the value of 2D-band. As a result, the it bond of the graphene film broke and caused reduction of the intensity of G-band.

Furthermore, both of generation of defects in each group of graphene material and the increase in the charged impurities can be deemed as doping of the graphene material to alter the semiconductor properties (such as n type, p type, and I-V characteristics) of the graphene material.

In view of the foregoing, in the method for modifying properties of graphene according to the present invention, the graphene film is radiated with an electron beam to effectively control the it bond of the graphene film, altering the energy band characteristics of the graphene film and obtaining the graphene material with semiconductor properties.

Furthermore, in the method for modifying properties of graphene according to the present invention, the graphene film is radiated with an electron beam in a low temperature environment to avoid damage to the graphene material resulting from a high temperature environment. The subsequent procedures for repairing damaged graphene material is, thus, not required, simplifying the producing procedures and reducing the industrial costs.

The method for modifying properties of graphene according to the present invention uses an electron beam that can be accurately located and can be qualitatively controlled. Thus, a small modification area can be scanned with the electron beam. Furthermore, the current intensity (e.g., 70-120 pA), the scanning time (e.g., 0.1-0.4 μms per point), and the accelerating voltage (e.g., 50 KeV) of the electron beam can respectively be controlled such that the radiating energy of the electron beams is in a range of 200-1200 μC/cm², which is sufficient to modify the semiconductor properties to different extents (i.e., the property modification extent of graphene). Thus, different property modification needs of different products can be fulfilled, which is an effect of the present invention.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

What is claimed is:

1. A method for modifying properties of graphene comprising:
providing a graphene film, with the graphene formed on a substrate;
placing the graphene film in a vacuum environment; and
radiating the graphene film with an electron beam to obtain a graphene material.

2. The method for modifying properties of graphene as claimed in claim 1, wherein the electron beam has an accelerating voltage of 50 KeV.

3. The method for modifying properties of graphene as claimed in claim 1, wherein the electron beam has a radiating energy in a range of 200-1200 μC/cm².

4. The method for modifying properties of graphene as claimed in claim 1, wherein the graphene is formed on the substrate by physical vapor deposition.

5. The method for modifying properties of graphene as claimed in claim 1, wherein the substrate is a silicon chip.

6. The method for modifying properties of graphene as claimed in claim 1, wherein the substrate is an electric element or a transistor.

7. The method for modifying properties of graphene as claimed in claim 1, wherein the electron beam has a current intensity of 70-120 pA.
